(19) United States
(12) Patent Application Publication
(10) Pub. No.: US 2016/0354265 A1
(43) Pub. Date: Dec. 8, 2016

(54) INFLATABLE HEAD SUPPORT APPARATUS TO MAINTAIN NEUTRALLY ALIGNED NECK POSITION

(71) Applicant: Frederick Usoltseff, Scottsdale, AZ (US)

(72) Inventor: Frederick Usoltseff, Scottsdale, AZ (US)

(21) Appl. No.: 14/730,872

(22) Filed: Jun. 4, 2015

(51) Int. Cl. A61G 7/07

(52) U.S. Cl. CPC A61G 7/072

(57) ABSTRACT

An inflatable head support apparatus for use in positioning head and neck regions of a user in a neutrally aligned position is provided, which minimizes obstructions in the user's airway during a procedure. The apparatus includes a base member having a U-shaped rim coupled to the front and side edges of the base member, and a wedge member coupled to the rear edge of the base member, a flexible bladder disposed within a central portion of the base member, and a pump operably connected to the flexible bladder. The pump is operated to inflate or deflate the flexible bladder to a position that permits the base member to support the head and neck regions of the user in the neutrally aligned position.

### BACKGROUND

The embodiments herein relate generally to support apparatuses for use in maintaining a user's head and/or neck in a neutrally aligned position.

The anatomy of an individual who lies down in a flat position causes the trachea to be in an anterior position. This extension of the neck can complicate laminar airway flow and can complicate a patient's breathing. This makes it more difficult for doctors and/or clinicians to perform any advanced airway procedures on the patient. In addition, this position often causes the patient's tongue to relax and slouch back to the oral cavity, which obstructs the patient's airway passage. To solve these problems, it is desirable to maintain the patient's head and neck in the neutrally aligned position where the earlobe and sternal notch are aligned. This causes the trachea to be in a less anterior position, which enables the patient's tongue to become less of an obstruction to the airway passage. This neutral position not only supports airway management, but also supports potential spinal injuries when an individual is in the supine position and eliminates potential extensions of the cervical spinal column. Ultimately, the neutrally aligned head and neck position permits a more direct air flow through the patient's airway and assists clinicians with the completion of any necessary airway procedures.

Several head support devices are disclosed in U.S. Pat. No. 5,454,781, 4,528,705 and 3,397,688, which help a user to maintain a particular head and/or neck position. However, these devices are limited because they are bulky and/or do not comfortably support both the head and neck of a user in a stationary position.

As such, there is a need in the industry for an inflatable head support apparatus that maintains the user's head and neck in a neutrally aligned position, which overcomes the limitations of the prior art.

### SUMMARY

An inflatable head support apparatus for use in positioning head and neck regions of a user in a neutrally aligned position, thereby minimizing obstructions in an airway of the user during a procedure is provided. The inflatable head support apparatus comprises a base member comprising a front edge, side edges and a rear edge, the base member comprising a generally U-shaped rim coupled to the front and side edges, and a wedge member coupled to the rear edge, wherein space defined by the base member, the U-shaped rim and the wedge member is sufficiently large to receive the head region of the user, wherein the wedge member is configured to support the neck region of the user, a flexible bladder disposed within a central portion of the base member, and a pump operably connected to the flexible bladder, wherein the pump is operated to inflate or deflate the flexible bladder to a position that permits the base member to support the head and neck regions of the user in the neutrally aligned position.

In certain embodiments, the inflatable head support apparatus comprises a first strap and a second strap both coupled to a first side edge of the base member, and a first D-ring and a second D-ring both coupled to a second side edge of the base member. The first and second straps are inserted through the first and second D-rings and tightened to secure the user's head and neck regions to the apparatus.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the inflatable head support apparatus shown in use;

FIG. 2 depicts a perspective view of certain embodiments of the inflatable head support apparatus;

FIG. 3 depicts a section view of certain embodiments of the inflatable head support apparatus illustrating a deflated configuration;

FIG. 4 depicts a section view of certain embodiments of the inflatable head support apparatus illustrating an inflated configuration; and

FIG. 5 depicts a bottom view of an alternate embodiment of the inflatable head support apparatus.

### DETAILED DESCRIPTION OF CERTAIN EMBODIMENTS

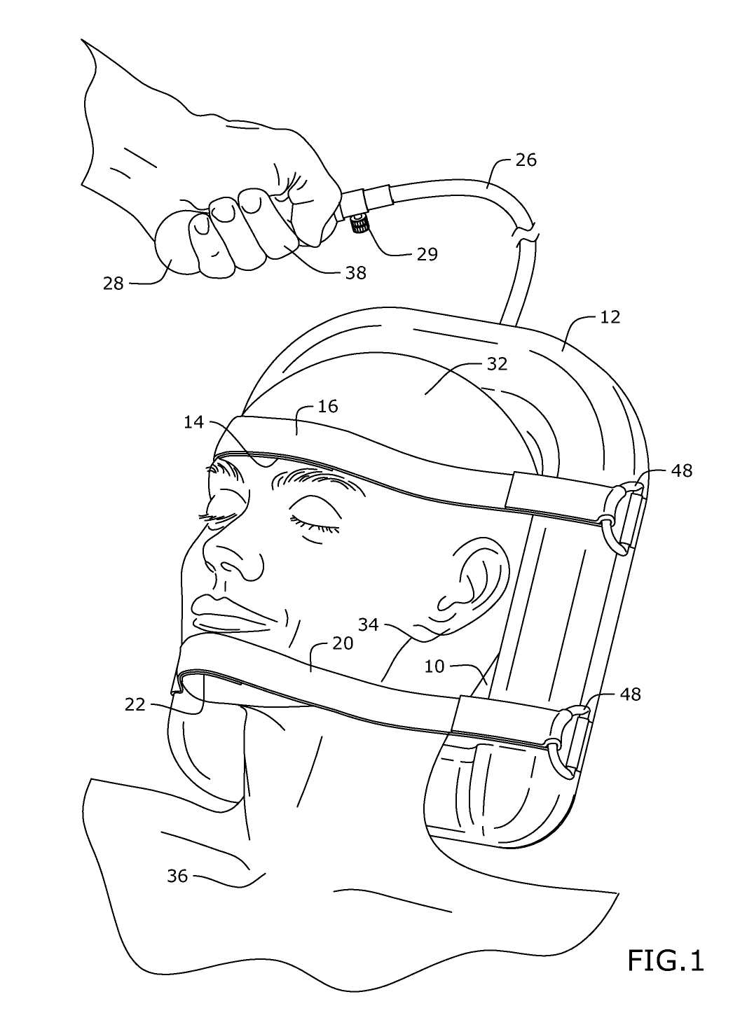

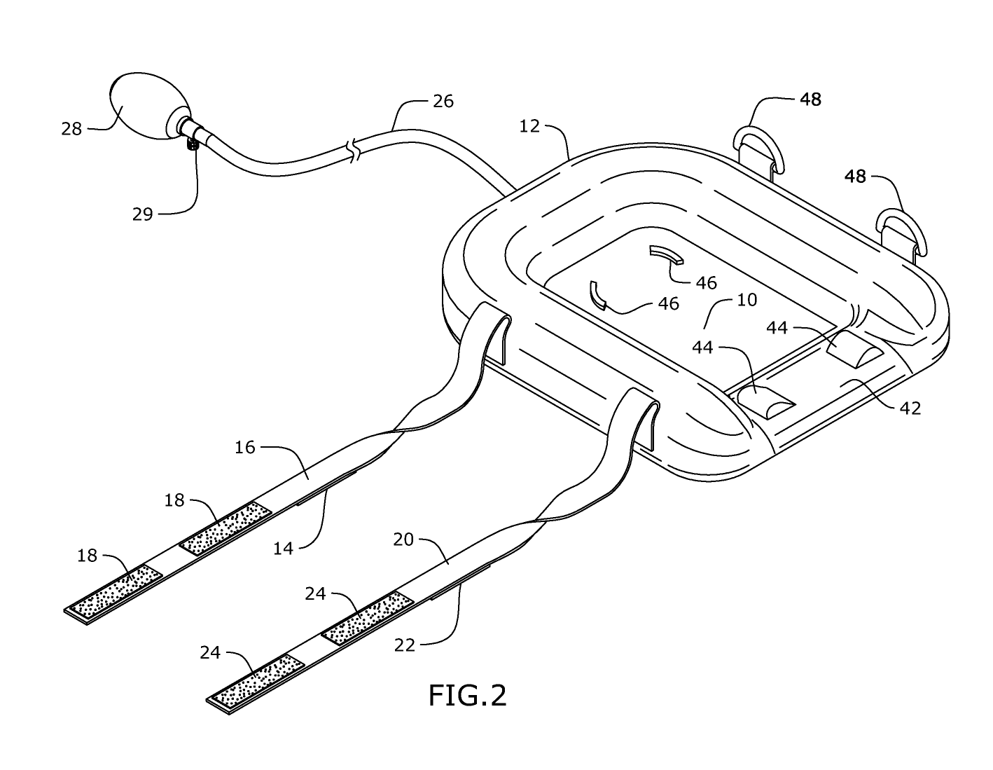

As depicted in FIGS. 1-2, the inflatable head support apparatus is configured for use with patient 32 and operated by operator 38. The head and neck of patient 32 is secured to the inflatable head support apparatus and supported in a neutrally aligned position. The inflatable head support apparatus comprises base member 10, elevated rim 12, wedge 42, squeeze bulb 28, tube 26 and control valve 29.

Base member 10 is a generally rectangular foam member that comprises a U-shaped elevated rim 12 and wedge 42 on the edges. The space between base member 10, elevated rim 12 and wedge 42 serves as a head rest platform for patient 32. In one embodiment, head cradle support members 46 are affixed to base member 10 and neck cradle support members 44 are affixed to wedge 42. This configuration permits the head and neck of patient 32 to be fully supported and secured by the apparatus. Specifically, the head of patient 32 is placed within head cradle support member 46. The neck of patient 32 contacts wedge 42 in between neck cradle support members 44.

Forehead strap 16, chin strap 20 and a pair of D-rings 48 are coupled to side edges of elevated rim 12 of base member 10. Forehead strap 16 comprises forehead strap fasteners 18 and forehead pad 14. Similarly, chin strap 20 comprises chin strap fasteners 24 and chin strap pad 22. Once the head and neck of patient 32 is placed on the inflatable head support apparatus, forehead strap 16 is inserted within a first D-ring 48 and tightened until forehead strap fasteners 18 engage with one another, thereby securing forehead strap 16 to a forehead region of patient 32. Similarly, chin strap 20 is inserted within a second D-ring 48 and tightened until chin strap fasteners 24 engage with one another, thereby securing chin strap 20 to a chin region of patient 32. Forehead pad 14 and chin strap pad 22 provide additional support and comfort to patient 32 once the straps are tightly secured in place. In a preferred embodiment, forehead strap fasteners 18 and chin strap fasteners 24 each comprise a pair of hook and loop fasteners. However, it shall be appreciated that alternative fastening components known in the field may be used instead such as snap fasteners or the like.

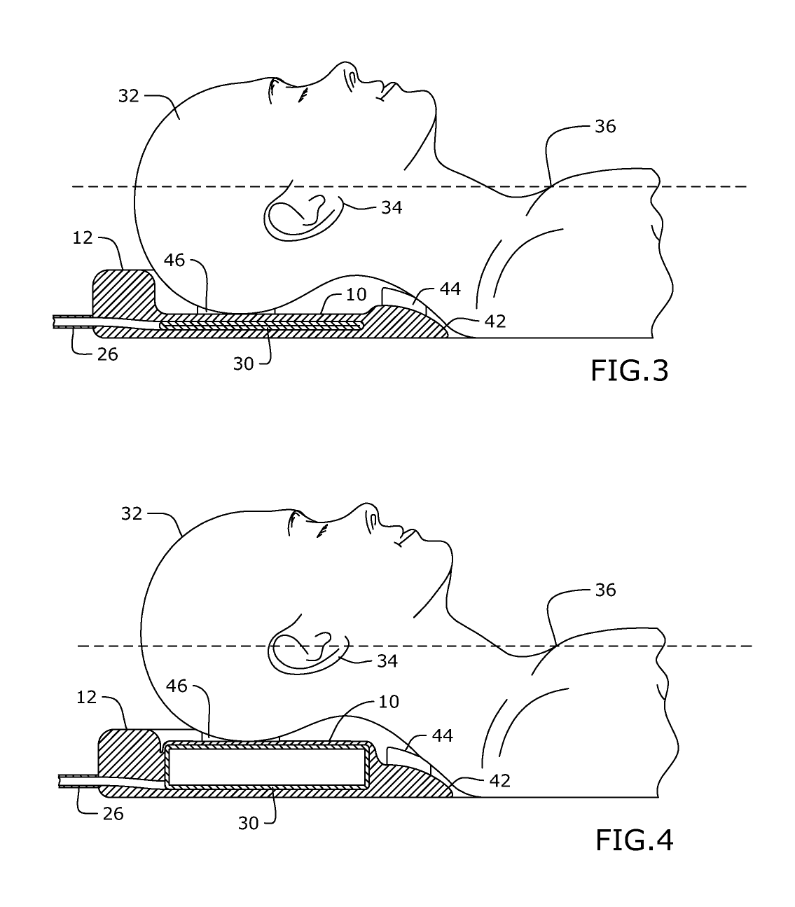

As depicted in FIG. 3, flexible air bladder 30 is embedded within base member 10. Tube 26 comprises a first end connected to flexible air bladder 30 and a second end connected to squeeze bulb 28. Control valve 29 is coupled to tube 26 and is used to control air flow in and out of flexible air bladder 30. As such, operator 38 can manually pump air in or out of flexible air bladder 30 as needed. It shall be appreciated that alternative components may be used instead such as an electrically operated air pump.

In operation, patient 32 lies down on a flat surface such as the floor, table, stretcher, backboard, or the like. The head and neck of patient 32 are placed on the apparatus, and forehead strap 16 and chin strap 20 are inserted through D-rings 48 and tightened. Operator 38 controls squeeze bulb 28 and control valve 29 as needed to maintain the patient's head and neck in the neutrally aligned position. FIG. 3 depicts flexible air bladder 30 in a deflated state in which earlobe 34 and sternal notch 36 of patient 32 are not aligned together. FIG. 4 depicts flexible air bladder 30 in an inflated state in which earlobe 34 and sternal notch 36 of patient 32 are aligned together. This position maintains the patient's head and neck in a fully supported and neutrally aligned position. In this neutrally aligned position, a clinician and/or doctor can easily perform any advanced airway procedures on patient 32. It shall be appreciated that flexible air bladder 30 may be inflated or deflated as many times as needed.

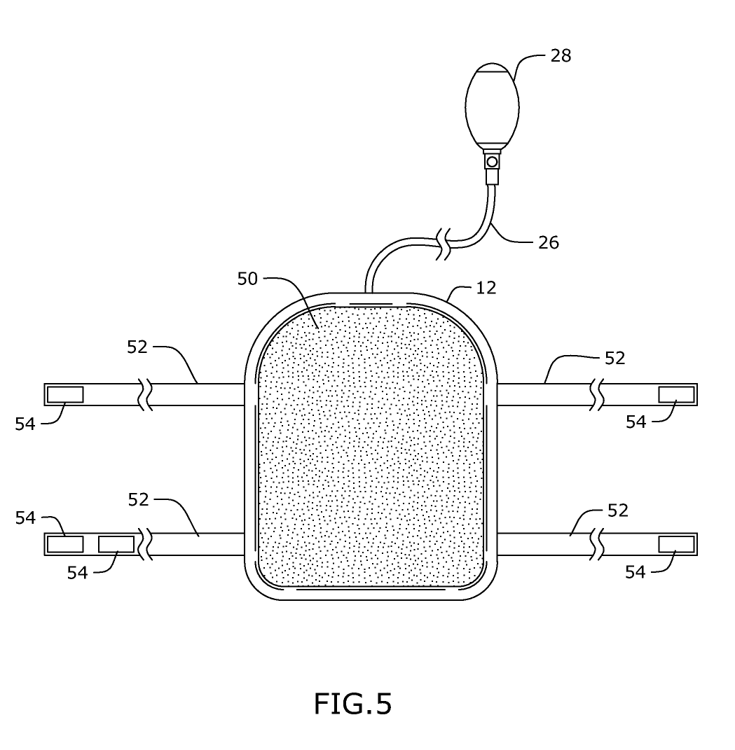

As depicted in FIG. 5, an alternative embodiment of the inflatable head support apparatus is shown. In this embodiment, adhesive layer 50 is affixed to the bottom of base member 10. Alternative straps 52 with alternative strap fasteners 54 are coupled to opposing side edges of base member 10 proximate the bottom surface. Alternative strap fasteners 54 may be any type of fasteners known in the field such as hook and loop fasteners. Adhesive layer 50 and alternative straps 52 may be used to help secure the inflatable head support apparatus to a table, stretcher or backboard when in use by patient 32.

It shall be appreciated that the components of the inflatable head support apparatus described in several embodiments herein may comprise any known materials in the field and be of any color, size and/or dimensions. It shall be appreciated that the components of the inflatable head support apparatus described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An inflatable head support apparatus for use in positioning head and neck regions of a user in a neutrally aligned position, thereby minimizing obstructions in an airway of the user during a procedure, the inflatable head support apparatus comprising:
a base member comprising a front edge, side edges and a rear edge, the base member comprising a generally U-shaped rim coupled to the front and side edges, and a wedge member coupled to the rear edge, wherein space defined by the base member, the U-shaped rim and the wedge member is sufficiently large to receive the head region of the user, wherein the wedge member is configured to support the neck region of the user;
a flexible bladder disposed within a central portion of the base member; and
a pump operably connected to the flexible bladder, wherein the pump is operated to inflate or deflate the flexible bladder to a position that permits the base member to support the head and neck regions of the user in the neutrally aligned position.

2. The inflatable head support apparatus of claim 1, further comprising a head cradle support affixed to the central portion of the base member.

3. The inflatable head support apparatus of claim 2, further comprising a neck cradle support affixed to the wedge member.

4. The inflatable head support apparatus of claim 3, further comprising a first strap and a second strap both coupled to a first side edge of the base member, and a first D-ring and a second D-ring both coupled to a second side edge of the base member.

5. The inflatable head support apparatus of claim 4, further comprising a first set of fasteners coupled to the first strap and a second set of fasteners coupled to the second strap, wherein the first strap is inserted through the first D-ring and adjusted to permit the first set of fasteners to engage with one another, thereby securing the first strap to a forehead region of the user, wherein the second strap is inserted through the second D-ring and adjusted to permit the second set of fasteners to engage with one another, thereby securing the second strap to a chin region of the user.

6. The inflatable head support apparatus of claim 5, wherein each of the first set of fasteners and the second set of fasteners comprises hook and loop fasteners.

7. The inflatable head support apparatus of claim 6, wherein the pump comprises a tube comprising a first end coupled to the flexible bladder and a second end coupled to a squeeze bulb, and a control valve operably connected to the tube.

8. The inflatable head support apparatus of claim 7, further comprising an adhesive coupled to a bottom surface of the base member.

9. The inflatable head support apparatus of claim 8, further comprising a first pair of secondary straps coupled to opposing side edges proximate the bottom surface of the base member, and a second pair of secondary straps coupled to opposing side edges proximate the bottom surface of the base member.
